(19) United States
(12) Patent Application Publication
(10) Pub. No.: US 2005/0048210 A1
(43) Pub. Date: Mar. 3, 2005

(54) Method for plating and plating solution therefor

(76) Inventors: Sam Siau, Aalst (BE); Jan Vanfleteren, Gentbrugge (BE)

Correspondence Address: KNOBBE MARTENS OLSON & BEAR LLP, 2040 MAIN STREET, FOURTEENTH FLOOR, IRVINE, CA, 92614, US

(21) Appl. No.: 10/756,846

(22) Filed: Jan. 13, 2004

(30) Foreign Application Priority Data
Jan. 14, 2003 (EP) EP 03447008.8

(51) Int. Cl. B05D 3/02; C23C 18/52; C23C 18/40

(52) U.S. Cl. 427/372.2; 427/443.1; 106/1.22; 106/1.23; 106/1.25; 106/1.26

(57) ABSTRACT

A solution is described, in particular for electroless deposition of a metal on a polyimide substrate. The solution from which the metal is deposited, comprises a source of metal ions; a reducing agent; an additive to adjust the pH of said bath to a predetermined value; and an aromatic sulfonic acid. The solution is used in a method for electroless deposition of a metal onto a substrate wherein the substrate preferably comprises polyimide exposed at a surface thereof. The method of the present invention provides a metal layer which shows good adhesion towards the polyimide substrate and which is very smooth and does not need any additional smoothening treatment.

### TECHNICAL FIELD OF THE INVENTION

The invention relates to the field of electroless plating of substrates and in particular to a solution for electroless plating of a substrate as well as a plating bath including the solution and products made by using the solution.

### BACKGROUND OF THE INVENTION

Use of flexible circuits for electronic assembly is increasing rapidly. Flexible substrates with very fine patterning are necessary in portable electronics (like mobile phones, etc.), advanced chip packages (like CSP's), medical applications (like implants), smart cards, wearable electronics etc.

The most popular base material for high resolution flexible substrates at the moment is polyimide because of its high thermal, mechanical and chemical stability. Polyimides are very strong and astoundingly heat and chemical resistance polymers. Their strength and heat and chemical resistance are so great that these materials often replace glass and metals in many demanding industrial applications. FIG. 1 illustrates why polyimides are that strong. The nitrogen atoms, which act as electron donors, have a higher electron density than the carbonyl groups, which act as electron acceptors. Hence, electrons of the nitrogen atoms are lend to the oxygen atoms. Electron donors and acceptors are located on the same molecule, this is called a charge transfer complex. This charge transfer complex holds the chains together very tightly, not allowing them to move around very much. This is why polyimides are so strong. Because of these properties, the adhesion of metals to the surface is normally marginal, and relatively expensive methods are used to obtain good adhesion between the metal and the polyimide surface.

Onto this polyimide base material electrical (interconnection) circuits have to be formed. Adhesion of metals, such as e.g. copper, on polyimide is technically not easy and currently 2 types of solutions exist to achieve this goal; 3 layer laminates and 2 layer laminates.

For three layer laminates, a Cu foil, typically 18 or 35 μm thick is laminated onto a polyimide base material using an appropriate adhesive. Because of reasons of mechanical stability during handling of the thin Cu foil used in the lamination process, the minimal thickness achievable of the Cu foil is around 12 μm in practice. This limits the bendability of the substrate: the thicker the Cu the higher the minimum bending radius of the flexible substrate. The thickness of the Cu layer also determines the minimum pitch features of the flexible substrate circuit (line width-line spacing), since Cu etching will cause underetching and the latter for a depth of the order of the thickness of the Cu layer (thus for a minimal thickness of the Cu foil the pitch is of the order of 40 μm). Moreover the adhesive used brings specific problems when mounting components onto the flexible substrate. An example is flip-chip bonding with adhesives, using a thermo-compression step during which the Cu contact pads on the flexible substrate are pressed into the flexible substrate adhesive which melts due to the applied heat (temperature typically 180° C.). This reduces the reliability of the product. New adhesives are presently being sought by industry.

At the same time attempts are being made to produce a 2-layer or “adhesiveless” laminate, consisting essentially of Cu and polyimide but the chemical stability of the polyimide means that good adhesion of the Cu to the polyimide is not easy to achieve.

For example, electroless Cu deposition processing on flexible substrates is typically based on the following reaction:
Cu²⁺+2 HCHO+4 OH⁻→Cu+3 HCOO⁻+H₂+2 H₂O (alkaline bath) (1)
This process is catalysed by either Cu or Pd metallic ions. During pre-treatment of the flexible substrate impurities are removed from the surface and Pd seeds are introduced on the surface of the substrate as a catalyst for the electroless deposition of copper. Further deposition of copper is autocatalytic. In other words the copper acts as a catalyst for further deposition of copper. The interface between the metal and the flexible substrate that is created in this way provides a very low adhesion. To improve the adhesion strength, the surface of the flexible substrate can be roughened before the deposition of electroless copper by means of chemical or plasma treatment (increase of the specific surface of the polymer). An existing solution is to first treat the polyimide first in a O₂ plasma, followed by a PVD (physical vapour deposition, i.e. sputtering or evaporation) step and then deposit the Cu onto the treated polyimide surface, possibly followed by an electrolytic deposition of Cu onto the PVD layer to increase the total Cu thickness. These treatments have a negative influence on the structural properties of the flexible substrate. This is of even greater importance when the layers become thinner.

In G. A. Shafeev, “Light-enhanced electroless Cu deposition on laser-treated polyimide surface”, surface treatment of a polyimide surface by laser ablation is performed which results in the formation of a glassy carbon layer at its surface which can mediate electroless Cu deposition.

In other cases the seed layer of copper is not plated by electroless copper but by sputtering some metal onto the flexible substrate surface, because the adhesion strength of the electroless copper onto the flexible substrate is so low that it does not remain on the surface of the flexible substrate.

The complexity of flexible circuits is increasing and double sided circuits, whereby a Cu layer is present on both sides of the polyimide, are advantageous (e.g. used in flexible substrate circuits for CSPs with a flip-chip component on one side of the flexible substrate and solder balls on the other side; this CSP component can then be soldered to a second level substrate, e.g. a PCB). Double sided flexible substrate circuits are typically made starting from a 5-layer laminate (Cu-adhesive-polyimide-adhesive-Cu) or a 3-layer laminate (Cu-polyimide-Cu). The following steps are needed to produce the circuit:

drilling of the through hole vias;

via filling by Cu deposition;

patterning and etching of the Cu on both sides of the substrate.

Lamination of the Cu onto the substrates and via filling are separate steps.

### SUMMARY OF THE INVENTION

The object of the invention is to provide a simple and cost-effective method for electroless deposition of a metal, preferably Cu, onto a flexible substrate comprising an insulating surface, e.g. a polymer such as polyimide exposed at a surface thereof. Using the method of the present invention provides a good adhesion of the metal onto the substrate is achieved.

The above objective is accomplished by a method and device according to the present invention.

The present invention provides a plating solution for electroless deposition of a metal, e.g. Cu, onto a substrate, especially onto a substrate with an insulating surface such as a polymer surface. The polymer preferably may be polyimide. The substrate may have one or two major surfaces with exposed polymer material or may be composed of a polymer such as polyimide. The present invention provides a solution, in particular for a plating bath for electroless deposition of a metal on a substrate wherein the solution comprises: a source of metal ions; a reducing agent; an additive to adjust the pH of said bath to a predetermined value; and an aromatic sulfonic acid. The aromatic sulfonic acid may comprise a sulfonic group, an aromatic group and an apolar chain. The aromatic group may for example be benzene, toluene, xylene, or any other suitable aromatic group. The aromatic group may furthermore comprise substituents such as for example an OH group or others. The apolar chain may for example comprise between 1 and 20 carbon atoms. However, apolar chains comprising more than 20 carbon atoms may also be used.

Typically the metal to be deposited may be Cu. However, other metals (e.g. Au, Ag, Ni, Al, Co) or metal alloys (Ni/P, Ni/Co, Au/Cu) may also electroless be deposited using the method of the present invention.

The substrate may usually be insulating and may typically have at least one surface with an exposed polymer such as polyimide. Electroless deposition of the metal onto the substrate, the substrate comprising polyimide exposed at a surface thereof or the substrate being a polyimide substrate, may be performed by applying the solution described above, i.e. the solution comprising an aromatic sulfonic acid. The deposited metal layers show good adhesion with respect to the polyimide substrate and are very smooth. Hence, they do not need additional smoothening treatments. Typical process steps of the method include applying a applying a solution with colloidal Pd/Sn catalyst, applying a solution comprising an accelerator, and electroless metal deposition by applying the solution described above. Additional steps may include cleaning, applying an anti-tarnish solution, and baking.

The present invention allows for producing single-sided or double-sided flexible substrate circuits in a cost effective way. It can combine via filling and deposition of the metal, e.g. Cu, for the interconnection pattern in a single step.

These and other characteristics, features and advantages of the present invention will become apparent from the following detailed description, taken in conjunction with the accompanying drawings, which illustrate, by way of example, the principles of the invention. This description is given for the sake of example only, without limiting the scope of the invention. The reference figures quoted below refer to the attached drawings.

### BRIEF DESCRIPTION OF THE DRAWINGS

FIG. 1 illustrates the structure of a polyimide.

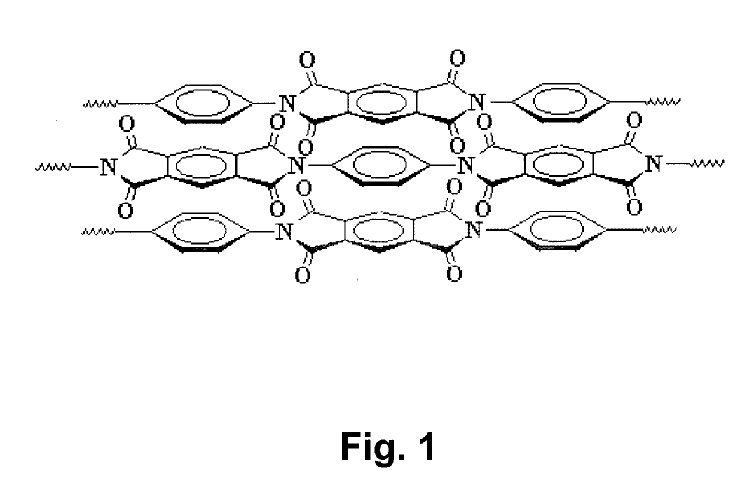

FIG. 2 an example of a polyimide, used in the present invention.

FIG. 3 an example of an aromatic sulfonic acid, used in the present invention.

### DESCRIPTION OF THE PREFERRED EMBODIMENTS

The present invention will be described with reference to certain embodiments and drawings but these are provided only as examples and the present invention has a wider scope of application.

It is to be noticed that the term “comprising”, used in the claims, should not be interpreted as being restricted to the means listed thereafter; it does not exclude other elements or steps. . Thus, the scope of the expression “a device comprising means A and B” should not be limited to devices consisting only of components A and B. It means that with respect to the present invention, the only relevant components of the device are A and B.

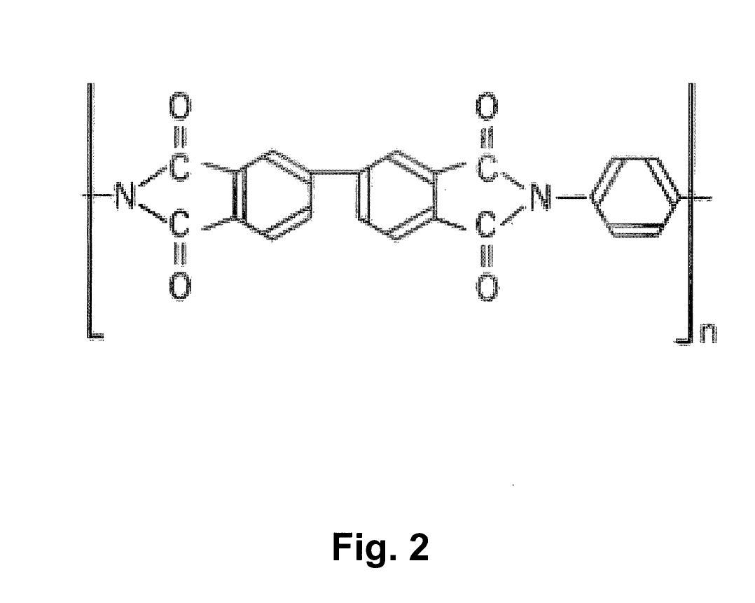

In a first embodiment of the present invention, a solution, more specifically for a plating bath for electroless deposition of a metal, such as e.g. copper, onto a substrate which comprises an insulating material at its surface is disclosed. The method according to this invention may furthermore be used for electroless depositing other metals (e.g. Ni, Co, Au, Ag) or metal alloys (e.g. Ni/P, Ni/Co, Ni/Zn/P). The insulating material may be a polymer material and preferably may be a polyimide. An example of a polyimide is shown in FIG. 2. A polyimide is, as already discussed, a very strong polymer and is rather inert towards chemicals. The substrate may be an essentially polyimide substrate, but preferably the polyimide may be exposed at a surface of the substrate. Furthermore, the substrate may be flexible.

As any conventional electroless plating bath, the plating bath used in the present invention, may basically comprise a metal source and a reducing agent. Such solutions are not stable and hence may furthermore comprise a complexing agent for keeping the metal ions in solution, buffers to keep pH at a desired value and additives for providing decomposition of the solution (stabilizers) or to improve morphology of the deposited metal. Examples of reducing agents which may be used in electroless plating baths are formaldehyde (HCHO), hypo-phosphite (H2PO2—), hydrazine (N2H4), etc. In most cases the choice of reducing agent is coupled to the metal ion that has to be reduced. Hence, for depositing a particular metal ion always the same particular reducing agent may be used. For example, in the case of electroless deposition of copper, formaldehyde may be used as the reducing agent. In table 1 some commonly used metal ion-reducing agent combinations are summarised.

TABLE 1

| Metal ion | Reducing agent |
|---|---|
| Cu | Formaldehyde (HCHO) |
| Ni | Hypo-phosphite (H₂PO₂⁻) |
| Co | Hypo-phosphite (H₂PO₂⁻) |
| Ag | Hydrazine or dimethylaminoborane (DMAB) |
| Ni/Co | Hypo-phosphite (H₂PO₂⁻) |
| Au/Cu | Formaldehyde (HCHO) |

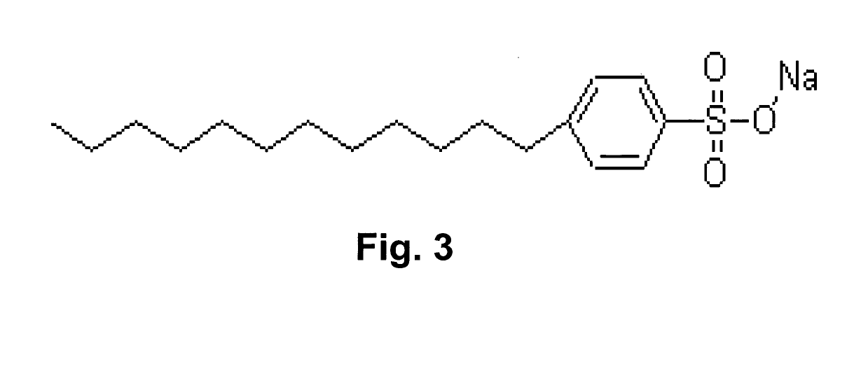

The electroless metal deposition bath, according to the present invention, furthermore comprises an aromatic sulfonic acid. FIG. 3 shows an example of an aromatic sulfonic acid which may be used in the invention. The aromatic sulfonic acid may comprise a sulfonic group (SO₃H), an aromatic group and an apolar chain. The aromatic group may for example be benzene, toluene, xylene, or any other suitable aromatic group and may be substituted with one or more substituents independently selected from the group consisting of C₁-C₂₀-alkyl, C₃-C₂₀-alkoxy, C₁-C₂₀-alkylsulfate. In general, the apolar chain may for example comprise between 1 and 20 carbon atoms. However, apolar chains comprising more than 20 carbon atoms may also be used.

The composition of the plating bath may depend on the metal that has to be deposited. For example, for depositing copper the plating bath preferably is alkaline, because electroless deposited copper from acid plating baths shows poor adhesion.

In a second embodiment of the present invention, a method for electroless deposition of a metal or metal alloy onto a substrate which comprises an insulating material such as a polymer, which is preferably a polyimide is disclosed. The polyimide may be a layer or be partly or wholly exposed on a major surface of the substrate. The substrate may be made of polyilide. The method, according to the invention, provides sufficient adhesion of the metal, and uses a sequence of immersions in liquids. It provides a production process for a high performance circuit-on-flex product. Preferably, the substrate is an essentially polyimide substrate. The substrate may be flexible. The resulting products, i.e. the polyimide/metal structures, allow fine patterning and show small bending radius and a high adhesion of the metal to the flexible substrate. Using the method of the present invention furthermore allows to deposit metal layers with a smooth surface. In the second embodiment of the present invention, the plating bath according to the first embodiment of the present invention may be used as a step in the electroless metal plating process (see further below) for a surface of a substrate comprising polyimide.

The method according to the present invention may comprise the following steps. This is only for the purpose of clarity of explanation and is not limiting for the invention. However, other steps equivalent for somebody ordinary skilled in the art may also be used.

In a first step, the surface on which the metal has to be deposited, is cleaned so as to remove dirt from the surface of the polyimide. The solution may for example be a 10% S₂O₈²⁻H₂SO₄ solution, which is a very strong oxidizing liquid. It is however not able to react with a polymer such as polyimide.

This cleaning step may be optional but may however preferably be included.

In a second step, the substrate is dipped into a solution comprising an anti-drag-through agent such as Sn²⁺ ions in order to prevent drag-through from the oxidizing agent of the previous step to the following catalyst bath and thus to prevent contamination of the catalyst solution. The following reaction occurs:
Ox+Sn²⁺→Red+Sn⁴⁺ (2)

In a next step, the substrate is immersed in a solution comprising a colloidal Pd/Sn catalyst. The choice of catalyst depends on the metal that has to be deposited and can be independent of the substrate on which the metal is deposited (‘Modern electroplating’, 4^{th} edition, by M. Schlesinger and M. Paunovic, Electrochemical Society series, 2000 and ‘Electroless plating’, by Mallory Glenn and Hajdu Juan, American Electroplaters and Surface Finishers Society, 1990). However, Pd/Sn catalysts are most commonly used in electroless deposition. Colloidal particles adsorb to the surface of the substrate to form catalytic centres. The core of these particles comprises a Pd rich Sn/Pd alloy and is surrounded by an Sn²⁺ shell. The core acts as a catalyst for electroless metal plating. However, the Sn²⁺ shell makes the core inactive with respect to initiation of metallisation. Therefore, an accelerating step is preferably performed.

This accelerating step is performed in order to remove the excess Sn from the surface, leaving Pd rich particles on the surface of the polyimide material. Therefore, accelerating agents are also called Sn strippers or, more generally strippers of the anti-drag-through agent. The Pd rich particles then act as a catalyst for the reaction in the following step. The choice of accelerating agent depends on the catalyst that has been used. Examples of accelerating agents may be found in ‘Electroless plating’, by Mallory Glenn and Hajdu Juan, American Electroplaters and Surface Finishers Society, 1990.

In a further step, electroless metal deposition then occurs by immersing the activated substrate in the plating solution according to the first embodiment of this invention.

In a specific example of electroless deposition of copper onto a polyimide substrate, the solution may for example comprise a copper salt such as e.g. CuSo4, a reducing agent such as e.g. formaldehyde and a pH modulator, e.g. a basic pH modulator, e.g. an alkali such as NaOH for bringing the pH of the solution to a desired value. The electroless copper deposition bath further comprises at least one aromatic sulfonic acid in order to promote a high adhesion strength between the metal such as Cu and the polymer surface.

The electroless deposition reaction may then be as follows:
CuSO₄+2 HCHO+4 NaOH→Cu+2 HCO₂Na+H₂+2 H₂O+Na₂SO₄ (3)

Cu itself is also a catalyst for this electroless deposition reaction. Further deposition of copper is possible in this way.

A further step is an anti-tarnish step. The solution, in which the substrate is immersed during this step, comprises components that adsorb on the surface and prevent oxidation of the copper. Examples of components that may be used in this step are glycolic acid, methanol and thioureum. Other examples of components that may be used may be found in ‘Modern electroplating’, 4^{th} edition, by M. Schlesinger and M. Paunovic, Electrochemical Society series, 2000.

A last step is a baking step, which includes heating to a suitable temperature to remove excess water and hydrogen from the surface of the deposited metal. This step will typically involve temperatures higher than 100° C. at atmospheric pressure, for example between 150° C. and 200° C.

In a specific embodiment of the present invention the solutions, which may be applied on a polyimide substrate for electroless deposition of a metal such as copper in the different steps described in the second embodiment may for example be:

Step 1: etching liquid at 20° C.

Step 2: Shipley Circuposit Pre-dip 3340 at room temperature

Step 3: Shipley Circuposit Catalyst 3344 at 30° C.

Step 4: Shipley Circuposit Accelerator 19H at room temperature

Step 5: Shipley Circuposit Electroless Cu+additives, comprising an aromatic sulfonic acid or acids, at 27° C.

Step 6: Shipley Anti Tarnish 7130 at room temperature for 3 minutes

Step 7: Baking at 150° C. for 60 minutes.

Deposition rates of typically 0.5 to 1 μm per minute have been measured. Any thickness of metal, e.g. Cu layer may be achieved and thus theoretically every pitch, e.g. for connection wiring layers. For conductivity reasons the thickness may preferably be higher then 2 μm. Even more preferably, the thickness is higher then 3 μm. The latter case corresponds to a pitch of the order of 1 μm.

By using the method of the present invention for electroless depositing a metal layer onto a polyimide substrate, the surface of the deposited metal layer is essentially smooth and does not have to be smoothened in an extra step, before typical further use/processing.

The adhesion strength between the polyimide substrate and the deposited metal is high. The Scotch tape test has been performed with success and is performed as follows. A Pressure-sensitive tape is applied to an area of the deposited metal layer which is sometimes cross-hatched with scratched lines. Adhesion is considered to be adequate if the metal layer is not pulled off by the tape when it is removed.

Without being limited by theory, it is believed that the high adhesion strength between the metal and the polyimide substrate resulting from use of the plating bath according to the present invention, is caused by chemisorption and thus chemical anchoring, mediated by the presence of at least one aromatic sulfonic acid in the plating bath. By introducing a chemical bond between both layers (polyimide and metal) it is possible to improve the adhesion strength significantly, because chemically bonded interfaces have much stronger interactions between both of the different materials then interfaces that are simply bound by adsorption. Furthermore, the presence of one or more aromatic sulfonic acids also facilitates the formation of hydrogen bubbles, which are formed during the electroless deposition process (‘Electroless plating’, by Mallory Glenn and Hajdu Juan, American Electroplaters and Surface Finishers Society, 1990) and can burden the deposition of a homogeneous copper layer by fast removing the formed hydrogen during the electroless deposition reaction.

The surface of the polyimide does not need to be roughened or plasma treated before or during the deposition process.

It has been shown that further steps as patterning and etching are easily possible.

The method according to the second embodiment of the present invention requires only chemicals that are relatively cheap. It has reel-to-reel capability. Deposition of thin metal layers, and thus high density and highly bendable flexible substrate is made possible by the present invention.

In an aspect of the second embodiment of the present invention the method can be used for production of double sided flexible substrate circuits by deposition of the metal for filling of vias (or through holes) and for realising interconnections (after patterning and etching the resulting metal layer) in a single step. Since the electroless process is a catalytic chemical process, uniform plating is possible in via's, holes and the surface of the flexible substrate simultaneously. A Double-sided flexible substrate production process can comprise the following steps

Start from a single layer polyimide material or a material with polyimide exposed on two major surfaces

Drill (e.g. by laser) via's (through holes) in the substrate if required

Electroless deposition of a metal (e.g. copper) on both sides of the flexible substrate and in the holes according to second embodiment of the present invention.

Patterning and etching the metal on both sides of the flexible substrate

In an aspect of the second embodiment of the present invention, the plating bath can be applied locally. This local application can comprise a masking step that divides the surface area of the substrate into active and non-active zones, for instance in large sub-areas of the substrate or in other patterns on the substrate, such that a good adhesion can be achieved selectively.

Instead of copper, also other metals such as e.g. Au and Al can be deposited by the method according to the second embodiment of the present invention by providing suitable source of metal ions in the plating solution.

While the invention has been shown and described with reference to preferred embodiments and specific materials, it will be understood by those skilled in the art that various changes or modifications in form and detail may be made without departing from the scope and spirit of this invention.

1. A method for electroless deposition of a metal onto a substrate, said substrate comprising polyimide exposed at a surface thereof, the method comprising:
electroless depositing a metal onto the substrate by applying a solution comprising a metal source, a reducing agent, an additive to adjust the pH of the solution to a predetermined value and an aromatic sulfonic acid.

2. A method according to claim 1, wherein the aromatic sulfonic acid comprises a sulfonic acid, an aromatic group and an apolar chain.

3. A method according to claim 1, further comprising exposing the surface to an anti-drag-through agent.

4. A method according to claim 1, the method furthermore comprising activating the substrate by applying a solution comprising a colloidal catalyst.

5. A method according to claim 4, wherein the colloidal catalyst includes Pd.

6. A method according to claim 4 wherein the colloidal catalyst includes Sn.

7. A method according to claim 4 wherein the colloidal catalyst is colloidal Pd/Sn.

8. A method according to claim 4, further comprising applying a solution comprising an accelerator.

9. A method according to claim 7, further comprising applying a solution comprising an accelerator.

10. A method according to claim 1, the method furthermore comprising a preliminary step of cleaning a surface of the substrate.

11. A method according to claim 1, the method furthermore comprising:
applying an anti-tarnish solution; and
baking.

12. A method according to claim 1, wherein depositing a metal comprises depositing copper.

13. A method according to claim 1, wherein the substrate is flexible.

14. A method according to claim 1, wherein the substrate is a polyimide substrate.

15. A method according to claim 1, wherein the substrate comprises through holes or vias.

16. A plating bath for electroless deposition of a metal onto a substrate, the substrate comprising polyimide exposed at a surface thereof, the plating bath comprising a solution comprising a metal source, a reducing agent, an additive to adjust the pH of the solution to a predetermined value and an aromatic sulfonic acid.

17. A plating bath according to claim 16 further comprising a substrate with polyimide exposed on at least one surface for electroless deposition of the metal.

18. A plating bath according to claim 16, wherein the metal source is copper.

19. A plating according to claim 16, wherein the aromatic sulfonic acid comprises a sulfonic acid, an aromatic group and an apolar chain.

20. A method according to claim 1, wherein the substrate comprises through holes or vias, and wherein the step of electroless depositing a metal onto the substrate comprises electroless depositing a metal onto both sides of the substrate.

21. A plating according to claim 16, further comprising a substrate with polyimide exposed on both surfaces of the substrate for electroless deposition of the metal, wherein the substrate comprises through holes or vias.
